(19) United States
(12) Patent Application Publication
(10) Pub. No.: US 2016/0117471 A1
(43) Pub. Date: Apr. 28, 2016

(54) MEDICAL EVENT LIFECYCLE MANAGEMENT

(71) Applicants: Jan Belt, Scottsdale, AZ (US); Robert E. Morgan, Peoria, AZ (US)

(72) Inventors: Jan Belt, Scottsdale, AZ (US); Robert E. Morgan, Peoria, AZ (US)

(21) Appl. No.: 14/920,805

(22) Filed: Oct. 22, 2015

Related U.S. Application Data
(60) Provisional application No. 62/067,433, filed on Oct. 22, 2014.

(51) Int. Cl. G06F 19/00; G06N 99/00

(52) U.S. Cl. CPC G06F 19/3456; G06N 99/005; G06F 19/345

(57) ABSTRACT

Methods and systems for managing the entire lifecycle of medication and other health events include observing or retrieving information from a switch exchange network, correlating events to the retrieved information, and/or with external information retrieved from the patient, the care giver, pharmacy, physician, manufacturer, medical or diagnostic device, regulatory agency, third party, or other source to provide an integrated holistic patient centric view to one or more entities in the health care continuum.

### PRIORITY

This application claims priority to U.S. Application No. 62/067,433, filed Oct. 22, 2014, which is incorporated by reference in its entirety into this application.

### BACKGROUND

There are a number of people involved with any health related encounter. The patient, of course, is at the center. The patient generally directly interacts with care givers, physicians, and pharmacist. However, the patient may also indirectly interact with dispensers, distributers, insurance companies or other payors, manufacturers, among others. Each of these entities contributes information to the encounter of the patient. Unfortunately, there are substantial gaps created from the lack of communication across the individual participants.

FIG. 1 illustrates an exemplary flow diagram of a conventional interaction of the health related encounter involving receiving medication. The process 100 starts 101 with the patient visiting a health care provider and receiving a prescription. In a conventional health related encounter, the patient may even visit multiple providers. For example, the patient may first visit a primary care provider to obtain a referral or authorization to a specialist or specific health care provider. At step 102, the specialist may prescribe a medication to the patient. The prescription may be through a paper or electronic prescription created by the prescriber. The patient or care giver may then retrieve or fill the prescription, at step 103. If electronically created, the patient simply goes to the designated pharmacy and retrieves the medication. If created in paper, the patient may have to deposit the prescription so that it can be filled, and then return to retrieve the needed medication. At step 104, the prescription may be changed by any of the prescriber, health care provider, or the pharmacy. There are a number of instances where a medication may be changed when or before a prescription is filled. For example, a pharmacy may replace a brand drug with a generic consistent with an insurance authorization. Other changes may occur when the patient, pharmacy, prescriber, pharmacist, or other individual in the lifecycle wishes to change a medication regimen, dose, therapy, drug, quantity, etc. for any number of reasons including interactions with other medications, convenience, cost, availability, etc. When the prescription is finally filled at step 105, any number of changes may have occurred such that any entity in the medication life cycle may or may not know what has transpired. The entire process, such as steps 103-105, can be repeated every time a medication is refilled. Therefore, at any one time, individual entities that have interacted with the patient likely do not have relevant or up to date information about what has transpired with the patient.

Today, prescribers, care givers, or patients do not have an automated, near real-time method to determine if the patient has filled or properly managed their prescriptions at the pharmacies across the U.S. The prescriber especially does not have any ability to know if the patient has filled the prescription, and therefore loses track of the patient as soon as the patient leaves their office. Incomplete or inaccurate information on patient medication history prior to the next diagnosis, by the same or different prescriber or specialist, can result in adverse effects and incomplete or inaccurate coaching. In an extreme example, during emergency visits to the hospital, a person may not be able to communicate which medication they are on or which medication may not have been taken properly.

As seen in FIG. 2, a number of care gaps are therefore created in the conventional medication lifecycle. For example, a first care gap may be created from when the patient is prescribed a medication to when the patient fills the medication, as the prescription may never be filled and the physician is not aware of the deficiency in the proposed treatment plan. In fact, 20-30 percent of prescriptions are never filled. If the patient does fill a prescription, but pays cash, the transaction is not visible at the point of sale to the health plan, pharmacy benefits manager, or physician. Regardless of payment, the physician has no real-time visibility to what medication or substitution was filled by the pharmacy in the event the prescription is changed from being prescribed to being filled.

When monitoring the treatment plan, a patient is the only one with the knowledge of all of the medications, both prescribed and over-the-counter that they encounter. Typically, patients are unaware of the relevance of these drugs, and do not communicate their presence to their care giver or health care provider/prescriber. Therefore, the conventional methods lack a patient-centered view that spans the care continuum across physicians, pharmacies, payers, or states. Even if a physician uses electronic health records, these systems are usually proprietary to each entity and do not communicate from one entity to the next. Even if these systems are used, they are used in an inconsistent manner, such that the required information is not conveniently found in the same place to be extracted and easily understood across providers. Additional difficulties arise when prescriptions and recommendations of products span different care givers, including alternative medicine providers. For example, prescribers within naturopath medicine may include recommended products and supplements that a patient is unlikely to disclose to other care givers. With these deficiencies in the conventional prescribing methods, it is not surprising that 4.5 million Americans per year visit their physician or emergency room because of adverse effects resulting from prescription drugs. Finally, given the limited amount of time the patient has to interact with any one or more of the entities in the lifecycle, the patient is generally ill informed about the risks of non-compliance or lack of adherence to the prescribed treatment plan.

Some solutions have been proposed to bridge these gaps. However, such systems require additional action by one or more entities in the lifecycle. Such systems have found substantial resistance because the interactions along the lifecycle are already so limited in time. For example, a physician is already substantially limited in the time to interact with the patient. That time is focused primarily on receiving an update from the patient, diagnosing the problems, and educating the patient on treatment plans. The lifecycle does not provide any time for entering extra information into additional platforms for managing medication. Moreover, because of the disparate systems used and the propriety of the information involved, many systems do not and cannot communicate directly one to another.

### SUMMARY

The present invention may provide a solution to one or more of the needs identified above by providing methods, systems and computer program products for processing the lifecycle of the medication transaction end-to-end and keeping the prescribers/doctors/caregivers informed and up to date with the status of the medication assigned to the patient.

Exemplary embodiments described herein “listen” at the switch to determine the clinical information associated with messages that pass through the switch infrastructure in either real-time using an API (application programming interface), semi-real-time (slightly delayed file transmissions from the switch technology provider), or in batch mode (some appropriate frequency established with the switch technology provider and determined to not impact the usefulness of exemplary embodiments described herein). Reference to a switch includes any common networked relay or other communication backbone in which disparate or unrelated companies communicate across a common infrastructure to transfer information.

Since all prescription events (and other medical information and events) have to pass through the switch infrastructure in order to be processed by providers, pharmacies, insurance companies, exemplary embodiments may be able to inspect the lifecycle of a prescription or other medical event from origination to termination along with the events in between—effectively building up an audit trail of the prescription or other medical event. Exemplary embodiments described herein may combine the events generated from the switch with additional data from the patient, including devices, and various providers in the ecosystem, such that the platform may correlate the data and provide complete transparency into the lifecycle of the prescription and additional medical events taking place in the patient's life.

According to one embodiment of the present invention, there is disclosed a method for tracking the time-to-fill event between when a prescription is prescribed to a patient and when it is filled at the dispenser/pharmacy/compounder and in turn informing the prescriber, thereby closing the loop.

According to an embodiment of the present invention, there is provided a computer program product for correlating the events.

According to an embodiment of the present invention, there is disclosed a system for obtaining the medical status of a patient and correlating that to their medication as stored in the system.

According to an embodiment of the present invention, there is disclosed a system for integrating with telemedicine platforms to support care without geographic boundaries or limitations.

According to an embodiment of the present invention, there is disclosed a system for integrating with location-based services to support alerts and workflow processing.

According to yet another embodiment of the present invention, there is disclosed a system for providing near-real time analytics throughout the entire lifecycle, extensive workflow, events and rules processing, and comprehensive reporting to support improvements, prevention, wellness, and close care gaps.

### DRAWINGS

FIG. 1 illustrates an exemplary flow diagram of a conventional interaction of the health related encounter involving receiving medication.

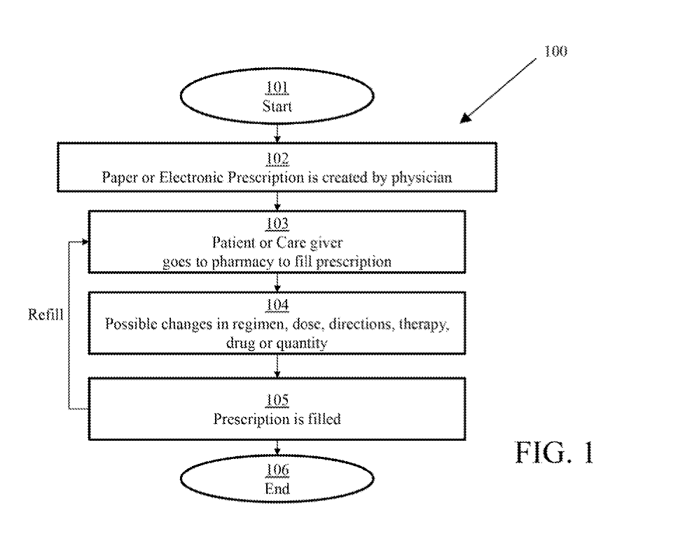

FIG. 2 depicts a medication lifecycle management process including seven exemplary process steps: Diagnose, Coach, Prescribe, Dispense, Pay, Monitor, and Review, and the associated potential care gaps that are created between each step.

FIG. 3 illustrates an exemplary method according to embodiments described herein.

FIG. 4 illustrates an exemplary process describing the flow of a prescription and how interactions with exemplary embodiments described herein may be used.

FIG. 5 depicts a medication lifecycle management network and the ecosystem of participants in fulfilling a medication and those that need to be informed about the medication lifecycle.

FIG. 6 illustrates an exemplary block diagram of specific modules of the medication lifecycle management system.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein retrieve desired information from a switch, network exchange used to manage one or more actions occurring during patient care. The retrieved information may be used alone or combined with other retrieved information to provide different information combinations, notifications, analytics, etc. to the patient, care giver, provider, physician, or others in the patient care continuum.

Although embodiments of the invention may be described and illustrated herein in terms of medication management, it should be understood that embodiments of the invention are not so limited, but are additionally applicable to different medical information which originates or has at least some information passed through a switch or network (wired or wireless) architecture. Furthermore, although embodiments of the invention may be described and illustrated herein in terms of prescriptions, it should be understood that embodiments of the invention are also applicable to other procedures or other medical events, such as, for example, medical procedures, tests and diagnostic (such as imaging including MRI, XRAY, CAT, etc.) surgeries, implants, medical devices, diagnostic or biological information, test results, etc. that may be retrieved from one or more information networks, third party providers, any entity in the patient care continuum, payers, devices, regulatory agencies, and any combination thereof.

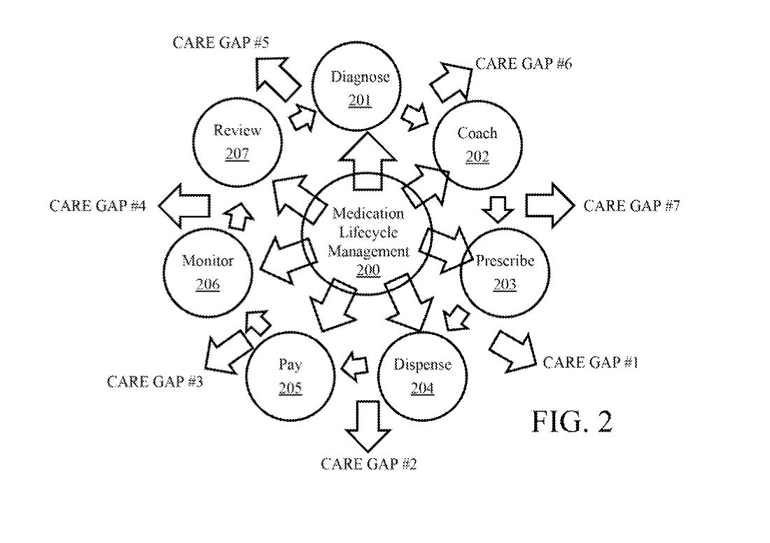

FIG. 2 depicts a medication lifecycle management process including seven exemplary process steps: Diagnose, Coach, Prescribe, Dispense, Pay, Monitor, and Review. FIG. 2 also illustrates a schematic diagram of the care gaps created without interconnected data across the entities and networks participating in the medication lifecycle, including but not limited to: Care Gap 1: 20%-30% of prescriptions are never filled and the physician is not automatically notified; Care Gap 2: 15% are paid in cash and are not visible at point-of-sale to health plan, pharmacy benefit manager or physician; Care Gap 3: Physician has no real-time visibility to what medication or substitution was filled by pharmacy regardless of payment type; Care Gap 4: No patient-centered view that spans the care continuum across physicians, pharmacies, care givers, other stakeholders such as family, or states; Care Gap 5: Medication history from electronic health records (EHR's) requires use of e-prescribing which has not been universally adopted across physicians and integration and interoperability continue to be challenges for many parties involved; Care Gap 6:4.5M Americans per year visit physicians or ER's due to prescription adverse effects; and Care Gap 7: Patients are not consistently informed of the risks of non-compliance or lack of adherence.

Embodiments described herein may be used to fill the possible gaps in the conventional cycle of medical care. For example, as shown, a patient may be diagnosed at 201. The physician or care giver may provide information, guidance, or coaching to the patient at step 202 and initiate a treatment plan. The treatment plan may include a medication for the patient. The medication is therefore prescribed to the patient at step 203, and dispensed to the patient at step 204. The prescription may be paid for either through an insurance company or individually by the patient at step 205. At step 206, the patient is monitored and the treatment plan reviewed at step 207 through successive visits to the physician or care giver or by the patient. As described above, each of the steps may permit a gap in the patient coverage to occur. Gaps generally are in the form of missed, inconsistent, or inaccurate information that should be communicated to the care giver or other entity participating in the medical/medication lifecycle to properly monitor, inform, and effectuate the treatment plan. Exemplary embodiments of the medical lifecycle management platform 200 as described herein may be used by any combination of entities in the medical lifecycle to fill one or more of these gaps.

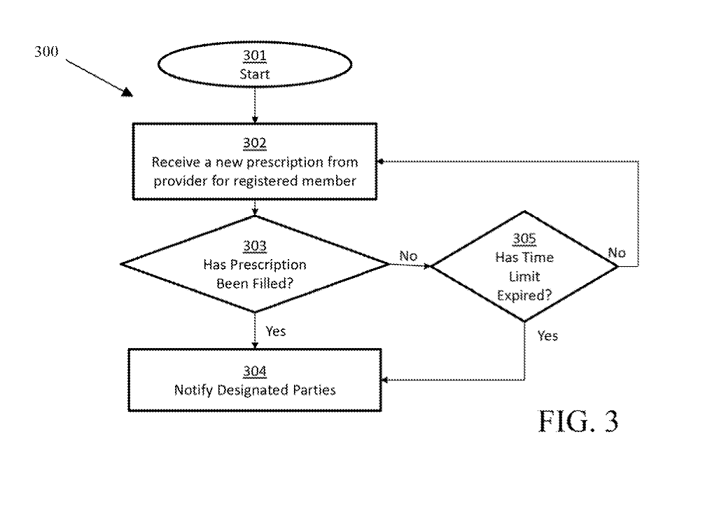

FIG. 3 illustrates an exemplary method according to embodiments described herein. The exemplary method 300 includes applications of using embodiments described herein including the medical management platform. To facilitate acceptance, exemplary embodiments of the platform may minimize cumbersome and additional steps not already performed in the medication lifecycle. For example, similar to the conventional method, the patient starts 301 by engaging one or more physicians, health providers, or care givers to diagnose a set of symptoms or to obtain a treatment plan for one or more symptoms. The patient, at step 302, receives a new prescription (or other procedure or event that is later communicated on the switch or networked system backbone), either as a paper prescription or as an electronic prescription. Exemplary embodiments of the platform, at step 303, determine whether the prescription has been filled or modified. If the prescription has been filled, at step 304, the platform may be configured to notify the appropriate entities. If the prescription has not been filled, at step 305, the system may determine whether the prescription fill time has expired. If the prescription has expired, then the appropriate entities may be notified that the prescription has not and will not be filled. If the time has not expired, the system may send a notification or may wait, for example by repeating step 303, to determine if the prescription has been filled. Therefore, an exemplary embodiment may automatically monitor the dispensing of the medication to the patient to determine if the patient is complying with the proposed treatment plan. Exemplary embodiments may or may not include the patient, the physician, the care giver, the pharmacist, or other entity in the medication lifecycle performing additional steps with respect to the conventional medication lifecycle.

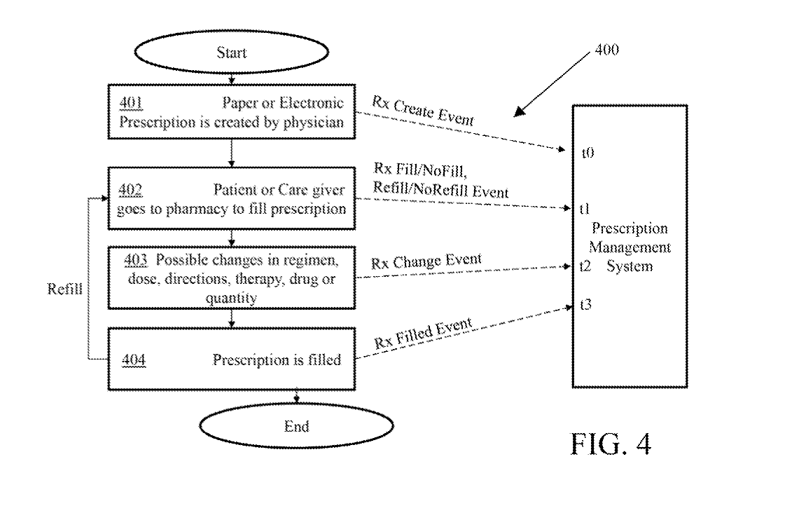

FIG. 4 illustrates an exemplary process describing the flow of a prescription and how interactions with exemplary embodiments described herein may be used. The exemplary process 400 for describing the flow of a prescription starts at step 401, when a provider creates a prescription (or other medical request) either written on paper or submitted electronically through an e-prescription service. When a prescription is created, exemplary embodiments described herein initiates the lifecycle tracking of the medication. For example, the platform may interface with one or more medical records created by a care giver or e-prescription service used by the care giver to determine that a prescription has been created. The system may also retrieve information from the switch when the prescription is sent to the pharmacy. The patient, at step 402 presents themselves to fill the prescription at the dispenser or pharmacy. When a prescription is requested to be filled at a dispenser, exemplary embodiments of the prescription management system receives a “fill” or a “refill” event and tracks that as part of the lifecycle. Therefore, the platform retrieves information from the switch as the pharmacy communicates to other providers, such as insurance companies to obtain authorizations to fill the prescription. At 403, the dispenser/pharmacist may alter the original prescription by substituting a generic or different medication or recommend a different regimen. Any change in medication due to substitutions, interactions, etc. result in “change” events transmitted to the system for tracking. The platform therefore retrieves these change events from the communications across the switch to and from the pharmacy. At 404, the prescription is filled and delivered to the patient. Once the prescription is filled, the “fill” event is retrieved by the platform from communications across the switch confirming the prescription was filled, such as those confirming payment is required, and the lifecycle is updated. Eventually the prescription lifecycle ends. In many cases, prescriptions are refilled periodically for continuing treatments of some conditions, and thus steps 402-404 may be repeated.

Exemplary embodiments of the prescription management system may receive events from many sources. In the exemplary embodiment described above, only the interaction with dispensing is illustrated. The lettering next to the events, t0, t1, etc., indicates the timestamp of the events coming into the system for medication lifecycle event management. These may all be tracked for each medication and for each patient/provider relationship that is enrolled in the system. It is these events and the intelligent learning and correlation engine of the system that may be used to provide the advanced analytics, insights, and decision support to the users of the system.

In an exemplary embodiment, the system may be used to retrieve time to fill information. The system may also track or correlate the time to fill information with the ultimate completion or pick up of a prescription. The system may therefore learn or identify correlations between statistically related events and predict actions of patients and/or provide notifications when adverse actions have a sufficiently high probability of occurring. For example, the system may provide insights on the probability of patients filling prescriptions if not filled within a prescribed time from the issuance of the prescription. Therefore, the system may provide alerts to patients and care givers when the system determines that the patient has a sufficiently high probability that they will not fill a prescription after a predetermined time has elapsed. The system may use other events and correlations to provide alerts when the patient is identified as potentially deviating from a treatment plan or medication prescription.

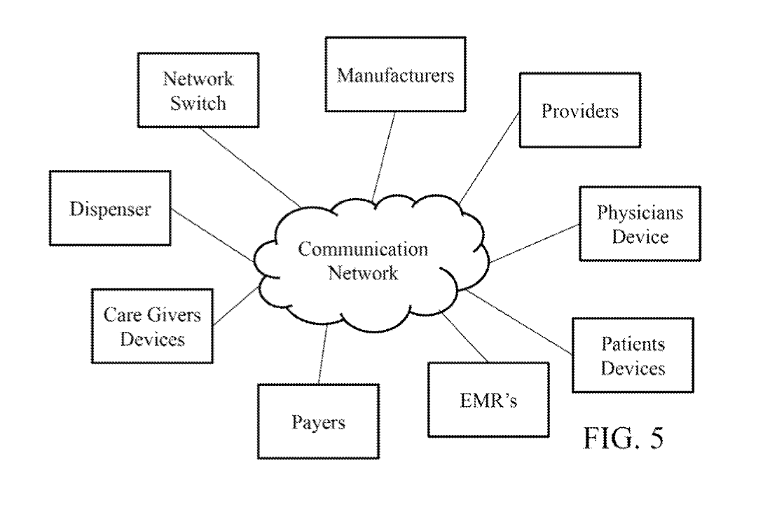

FIG. 5 depicts a medication lifecycle management network and the ecosystem of participants in fulfilling a medication and those that need to be informed about the medication lifecycle.

Exemplary embodiments of the Communication Network include one or more collections of clinical, retail, payment, electronic medical record aggregation, sensor-based and remote monitoring systems that are connected to clearinghouses and switches, and other networks and are responsible for routing and delivery of secure messages and transactions.

Exemplary embodiments of the Manufacturers include the drug and pharmaceutical companies that produce medications. Other manufacturers may include those of medical and diagnostic devices used by the patient to treat, monitor, or otherwise interact with the patient directly or indirectly.

Exemplary embodiments of the Providers may be those responsible for writing the prescriptions, and initiating procedures/test for patients. The providers currently have no visibility after the prescription is written. Exemplary embodiments may therefore be used by the providers to retrieve information about compliance with the treatment plan.

Exemplary embodiments of Physician Devices and Patient Devices include medication devices that provide diagnostic, biological, or other information to the patient and/or health provider. These Devices may also include any other medical device, such as diagnostic tools, implants, monitors, etc. For example, these devices may include sensors for obtaining a patient's temperature, blood pressure, heart rate, blood pressure, etc. These devices may also include implants or other medical equipment that sends or receives information such as pace makers, etc.

Exemplary embodiments of Electronic Medical Record systems (EMR's), also known as Electronic Health Record, include the medical information relating to a patient in electronic or digital form. In exemplary embodiments, the EMR receives the prescription from the physician when it is prescribed. The EMR includes other information about the patient including medical events that may be used by exemplary embodiments of the system.

Exemplary embodiments of Payers include those paying for the services and/or medical devices and/or medication. These may include the patient, insurance companies, doctors, health care providers, third parties, among others in any combination.

Exemplary embodiments of Caregiver Devices include those devices (and people) who provide care and monitoring services to patients. These caregivers may include individuals or teams made of a combination of professionals and non-professionals responsible for holistic patient care and need to know the regimen of medication that a patient is on. These may include friends and family as well as nurses, physicians, etc.

Exemplary embodiments of Dispensers may include pharmacies who provide the medication to a patient described in a prescription by the physician. A patient may interact with a number of different dispensers.

Exemplary embodiments of the Network Switch include the exchange backbone for one or more medical systems. There may be a plurality of network switches in which each switch handles the exchange of a different combination of patient data to achieve different functions. Exemplary network switches include those for exchanging information between any number of pharmacies and the payers, including insurance companies. Network switches may be used to communicate prescription information, test information, images, data, etc. regarding a patient and the medical lifecycle.

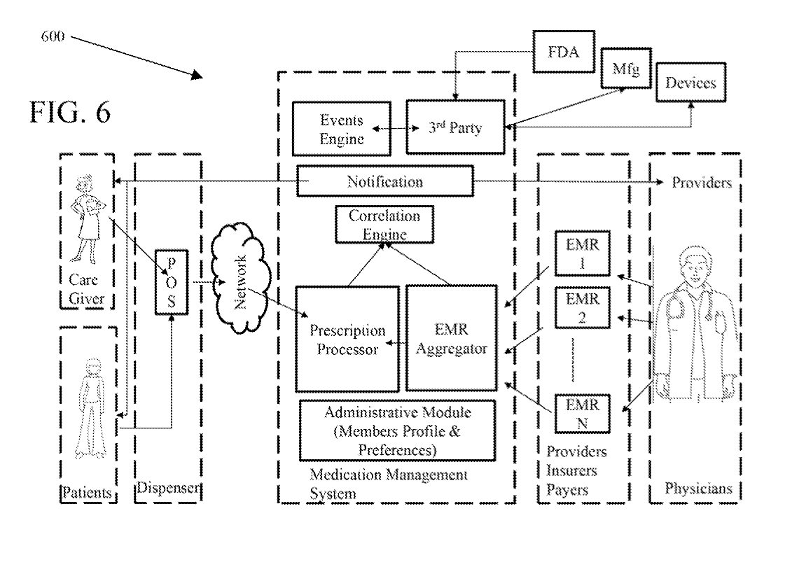

FIG. 6 illustrates an exemplary block diagram of specific modules of the medication lifecycle management system.

All medical claims including pharmacy/medication/diagnostic/test/specialist pass through a computer network and through several switches that are responsible for sending the claim/prescription to the proper payer for processing and eventual payment. The switches have business arrangements that allow them to switch a claim to the appropriate payer irrespective of where the claim originated. This cooperation ensures that all providers irrespective of their submitting system technology will get the claim to the payer that the patient belongs to. This is analogous to the payment network infrastructure that allows a credit card holder to pay at a merchant point of sale independent of who services the merchant.

Exemplary embodiments described herein may integrate with a provider of the technology for the switch capability and listen in on the messages that come across the network. In an exemplary embodiment, the exemplary system may only be interested in clinical information such as data related to prescriptions, treatments, tests, diagnostics, etc., as opposed to financial information. Exemplary clinical information may therefore include prescriptions, procedure requests, results, and other non-financial data.

In an exemplary embodiment, the “listening” at the switch may mean that exemplary embodiments of the system will receive copies of the clinical information for messages that pass through the switch infrastructure in either real-time using an API (application programming interface), semi-real-time (slightly delayed file transmissions from the switch technology provider), or in batch mode (some appropriate frequency established with the switch technology provider and determined to not impact the usefulness of the system). “Listening” may also include other methods and options for observing, retrieving, saving, or otherwise using the information passed through the switch infrastructure.

Since all prescription events have to pass through the switch infrastructure in order to be processed by providers, pharmacies, insurance companies, exemplary embodiments of the described system will be able to inspect the lifecycle of a prescription from origination to dispensing along with the events in between—effectively building up an audit trail of the prescription or other medical event.

Exemplary embodiments of the system may also be configured to retrieve information from different sources. By combining the events generated from the switch with additional data from the customers, and various providers in the ecosystem, exemplary embodiments of the system may be configured to correlate the data and provide complete transparency into the lifecycle of the prescription and additional medical events taking place in the patient's life. For example, the system may retrieve information from self monitoring systems such as blood pressure, heart rate, exercise logs, etc.; medical equipment such as implants, monitors, etc.; external sensors such as temperature, humidity, etc.; location devices; public and private databases such as those identifying geographic areas of medical concern (temperature extremes, outbreaks, allergens, etc.). The system may correlate and relate all of the retrieved information. The system may then summarize, present, or otherwise provide reporting on historical and present information obtained through the platform. The system may also provide analytical tools based on the information such as statistics, probability of outcomes, warnings or notifications to one or more entities in the health care continuum, etc.

Exemplary embodiments of the medication management system may include one or more modules to perform the function described herein. Exemplary modules may be performed in software, hardware, and a combination thereof. Exemplary embodiments may include computer memory in which is stored non-transitory machine readable code, and a processor configured to execute the code and perform the functions described herein. The modules are described for illustrative purposes only as separate entities performing specific functions. However, any combination of features may be used such that individual modules may be integrated, divided, duplicated, added, removed, or otherwise reconfigured to achieve the desired objective of the system and remain within the scope of the present invention. Therefore, a recitation of a module or associated function is not intended to limit the invention to a stand alone functional code block that only performs the described function. One or more modules may be implemented in or across one or more system components. For example, a single module may be implemented across multiple system components, while multiple other modules may be implemented in a single system component.

Exemplary modules of the medication management system may include, but are not limited to:

Exemplary embodiments of a Prescription Processor may be configured to “listen” at the switch to determine the clinical information associated with messages that pass through the switch infrastructure in either real-time using an API (application programming interface), semi-real-time (slightly delayed file transmissions from the switch technology provider), or in batch mode (some appropriate frequency established with the switch technology provider and determined to not impact the usefulness of exemplary embodiments described herein). In an exemplary embodiment, clinical information is copied and saved to the system from information passing through the switched network.

Exemplary embodiments of an Electronic Medical Record Aggregator (EMR) are configured to interface with one or more different EMR systems to retrieve patient information relevant to the healthcare lifecycle of interest. For example, with respect to the medication lifecycle, the aggregator may be used to track medication related information, such as when a prescription is made, when a prescription is sent to a pharmacy if electronic-prescription interfaces are used, when the office visit occurred, the duration of the prescription, the number of refills of a prescription, what medications are prescribed, the associated symptoms experienced prior to administering the medication or for which the medication is prescribed to treat, biological and physical information relevant to the prescription, such as height, weight, gender, nationality, etc., and any combination thereof.

Exemplary embodiments of an Administrative Module include User Identity, Profile, Preferences, and Role-Based Access functions. For example, the members including physicians, patients, and caregivers may be provided a user interface to register with the system and set their profile including contact information and preferences for notifications on events generated by the system. The system may include memory for storing the entered information in a database structure. Depending on the user's role, they may be authorized to access specific information that complies with regulatory requirements, as well as privacy and security best practices. The Administrative Module may be configured to present a user interface to the user for defining the user profile, setting references, and granting role-based access. Exemplary embodiments may also include a user interface for providing additional information about the healthcare event or patient directly.

Exemplary embodiments of the Correlation Engine bring all of the retrieved information together for making the appropriate determinations and analysis. For example, the correlation engine may be used to manage incoming data from the EMR's and events generated by dispensers as well as third party external events. The Correlation Engine may use this retrieved information and make the decisions of what events require notification and to whom and when. The Correlation Engine may perform specific functions such as notifications upon specifically observed events, such as when a patient fills a prescription. The Correlation Engine may use machine learning algorithms to process the data and develop patterns of usage and behavior. The system may be configured to establish a baseline for the patient/consumer from these patterns. The system may then be configured to provide the necessary notifications when there are deviations from the baseline that exceed preset thresholds. In an exemplary embodiment, the Correlation Engine may retrieve, identify, coordinate, and/or save the information retrieved from the switch for members as defined through the Administrative Module (for example those users that have set up an account). The system may therefore selectively manage incoming data to optimize performance.

Exemplary embodiments of a Notification Processing module manage which channel a member or user is notified (email, SMS, phone, pager, telemedicine, web, mobile app, physical/medical device/sensor) as well as escalations to appropriate parties. Member settings of the notification processing module may be set, for example, by a member through the administrative module. The notification processing module may then communicate with the event engine to determine the event and therefore the associated notification.

Exemplary embodiments of an Events Engine may be used to define what constitutes an event and a priority. This engine is extensible and allows for the definition of many types of events based on many factors such as geographic location, environmental factors, acute or ambulatory, classification of medication, status of patient, caregiver instructions, patient history, and many other events that can be described by the programming engine. These can be calendar, time-based/limited or adjusted according to a variety of factors. The Events Engine may also use machine learning algorithms to determine patterns and analyze and define the perceived events. Exemplary events may be time/calendar based, but may also be triggered by external environmental or contextual triggers, such as when it is hot/cold outside, when the person is walking, sleeping, etc. For example, the events engine may determine when and what event should take place. Exemplary events include providing notifications to one or more entities in the health care continuum, updating records or information, providing reminders or scheduling events, etc. The event such as a distinction between a notification, warning, and reminder along with the priority of the vent may be used by the notification processing module to determine what type of message should be given and to whom. The events engine may therefore be used to classify events and identify the message associate with the event for distribution to the intended member.

Exemplary embodiments may include External Partner Integration. Exemplary embodiments of this module may be used to determine what information is relevant and/or to communicate relevant information to another party when the conditions warrant. Exemplary embodiments of this module may allow for third party partners to connect and extend the system by sending and receiving data from a variety of sources including external databases and systems, medical devices, health monitoring devices and future systems that can impact the medication regimen of a patient or that can benefit from knowing what medications are assigned to a patient. To protect patient privacy, a break-glass feature may be incorporated into the system to allow for emergency access to medical data by third parties such as first responders when warranted by the situation and/or when a preset authorization is provided by the patient.

Exemplary embodiments of FDA Monitoring module can retrieve information from the food and drug administration (FDA) or additional or alternate governmental regulatory agencies to provide a feedback loop on the propriety of the medications prescribed. As an example, the FDA can be queried for drug recalls, interactions, or any other government or safety reason. The system may be updated and used by the Correlation Engine and Events Engine to determine when notifications should be sent.

Exemplary embodiments of the Manufacturer Processing module include an interface to drug and medical device manufacturers. These manufacturers can send or receive data (based on privacy settings) of medication, results, conditions as well as commerce related data that may help a patient to follow the regimen they are on. Additionally, a patient or physician may be a part of a program for testing of certain medication that can be tracked for results and safety and transmitted back to the manufacturer. Product information may also be provided to the system through the Manufacturer Processing module. When a patient permits access to selecting information to the manufacturer, the information may be cleaned to remove any identifiable information. Therefore, manufacturers may receive anonymous information that maintains the privacy and confidences of the user.

Exemplary embodiments of an IP-Enabled Medical, Sensor-Based, Telemedicine, and Non-Medical Device Integration module may be used to integrate information retrieved from a number of technological sources. Many new devices are coming to market for health, wellness, and fitness tracking and monitoring. These systems can be integrated and data sent or received between those devices and the medical management system. The system provides a normalized data integration layer that allows for a simple integration with the device maker and a standard way of interfacing using de facto and industry standard application programming interfaces (API's). Location-based sensors may also be provided such that the system may obtain other information about an environment of the patient. For example, obtaining a location of the patient may permit the system to determine contextual information that augments the information received from the switch. The system may obtain a location of the patient, such as from a mobile device or diagnostic device. The system may access public or private database resources to determine environmental information about the location, including temperature, allergens, disease exposure potentials, etc.

Exemplary embodiments of a Data Analytics and Reporting module provide targeted insights for specific communities of interest available via secure web and mobile channels via data analytics, reporting tools, and API's in either near real-time, real-time, or batch modes. For example, the reporting module may provide historical and present reporting, and may provide classifications and notifications regarding medications. Exemplary embodiments may be used to predict potential outcomes. For example, they data analytics module may determine the likelihood of missing a medication and provide forewarning or provide a likelihood that if some action is done, then some response is likely to occur.

Exemplary embodiments of a User Managed Access (UMA) module include an access management protocol standard that allows the owner of the data to authorize access to their data. Basically, the consumer is at the center of their own data and can manage exactly who has access and what system instead of the conventional approach where companies guard the data and make it difficult for people to get access to their own data. Accordingly, exemplary embodiments may implement an access control and data sharing model based on UMA to allow the consumer to decide what medical data and events they wish to share and with whom and under what conditions. For example, a patient may elect to share many different test results from specialists with their primary care provider, while sharing only a limited subset of those results with a neurological specialist. The patient may allow all the specialists to view the patient data in order for them to collaborate on a recent condition for a period of time. The access may be granted on a temporal basis, such that the access is revoked after a period of time, or may be provided on an individual basis, or on other criteria, such as a type of test, inclusion on a treatment plan, related to a specific disease, illness, or diagnosis, etc., and any combination thereof. Access may be granted to emergency personnel as described herein on a limited basis. The emergency access may be granted through the UMA or may be made available to the emergency personnel as an override to the UMA authorizations given by the user.

For example, the system may include any one or more of the above modules which communicate across the modules to retrieve information, classify the information, determine the appropriate event, determine an action based on the event, execute the action, communicate and coordinate across multiple input data sets, etc. to provide the desired integration across the health care continuum of interest to the member. Example use cases are provided herein to illustrate exemplary functionality of the disclosed modules. However, these examples are not intended to be limiting. The functions across modules may be performed by other modules, integrated, added, removed, or otherwise reconfigured across the system. The examples are also in terms of prescription medications, but are equally applicable to other medical events. The exemplary actions or system responses are also not limiting as these may be set by a user preference or otherwise configured as appropriate given the specific event, conditions, and other information.

In an example application, the system may identify an escalation of events and provide appropriate notifications along the way. The correlation engine may determine that a user has a prescription ready to be filled, but not yet picked up. The events engine may classify the event as a fill event and based on the time from receiving the prescription or a time to prescription expiration set an appropriate priority. The notification processing module may then determine that a fill event with a low priority only requires a notification by text to the patient. However, after a period of time or as the prescription expiration approaches, the events engine may escalate the priority, so that the notification processing module identifies that notifications may be sent to friends and/or family through email. Finally, when the prescription has expired and has not been filled, the events engine may similarly escalate the priority such that the notification processing module determines that the physician may be notified to follow up with the patient. Notifications may be sent according to the channels specified in the each of the entities profiles. For example, the patient, care giver, and/or physician may select in their profiles when to receive a notice, in what form to receive a notice, and on what events to receive a notice. The system may be configured to additionally dispatch a care giver or emergency services depending on the type of patient, the priority of the event, and the event.

In an example application, the FDA module may be used to retrieve information about the prescribed drug. Therefore, when a recalled drug is prescribed but not yet filled, the events engine may provide a recall event of lower priority, such that the notification processing module determines a notice should be provided to the pharmacy to replace the medication with another. However, when a recalled drug is prescribed and filled, the events engine may provide a recall event of high priority such that the notification processing module determines a notice should be provided to the physician or a call given to the patient.

In an example application, when events are not escalated, but proceed according to the treatment plan, the system may provide confirmation in a non-intrusive manner such as by communicating with the electronic record system of the care giver or physician through the EMR aggregator to identify when the fulfilling events occurred for convenient reference by the physician without raising or interfering with the physician's schedule. The system may also use the data analytics and reporting module to provide updates, summaries, histories, etc. to one or more entities of the health care continuum. For example, the physician may get a summary confirmation of all events occurring according to or deviating from the treatment plan, the pharmacies may be able to get time of filling reports to access their responsiveness to patient's needs, the patient may be able to retrieve summaries or histories of prescriptions, durations, statistics, etc.

In an example application, the integration module may also be used to provide additional relevant information to the system as it aggregates information and determines an appropriate course of action. For example, the integration module may be used to interface with a blood pressure monitor. The system through the prescription processor may identify that the patient was prescribed a blood pressure medication. The same event engine and notification module may be used as above to provide the necessary notifications or actions from the system given whether or when the prescription has not been filled. However, with the integration module, the blood pressure of the patient may also be considered and used by the event engine to determine a different priority. Therefore, when the events engine determines that a medication request is outstanding and not yet filled, and the correlation engine, FDA monitoring module or the manufacturing processing module is used to retrieve the specific use of the medication for blood pressure, the correlation engine may check the blood pressure retrieved from the integration module to inform the event engine when the defined event priority should be elevated. Specifically, when the system identifies an outstanding medication is not yet filled for blood pressure, but is otherwise in a normal time for filling such that the event would normally be given a low priority, the event engine may escalate the priority to a high priority when the system identifies the patient is experiencing high blood pressure at or near the time the prescription is not filled.

In an example application, the integration module may obtain a location of the patient, which may be used by the events engine to define or prioritize an event. For example, the system may obtain a location of the patient, such as from a mobile device or diagnostic device. The integration module may use this information to access public or private database resources to determine environmental information about the location, including temperature, allergens, disease exposure potentials, etc. The events engine may therefore use this information to escalate an event. For example, when a medication is outstanding and not yet filled, but within an appropriate time so the priority would otherwise be low, the integration module may be used to identify an outbreak of the disease for which the medication is intended to treat in a vicinity near the patient. Therefore, the event engine can escalate the event to a higher priority and the notification module can provide the appropriate notification in response thereto.

In an example application, the external partner integration may be used to determine what information is relevant and/or to communicate relevant information to another party when the conditions warrant. An example would be when a patient on some specific medication books a flight. At time of booking, the patient could be asked for their special medical needs/concerns or access to embodiments of the medical management system. The system may be used to determine whether notice should be provided to flight crew, patient, care giver, etc. of patient events that may impact their treatment. Therefore, during flight, the flight crew is made aware of medical conditions or medications that a person may need.

In an example application, the UMA permits a patient to grant one or more entities in the health care continuum access to specific information of the patient of any one or more of the examples provided herein. Therefore, if specific data results are retrieved for calculated, those results may only be provided to the entities having permission as granted by the owner of the data, such as the patient.

In an example application, the system may include any one or more additional data sources to assist in the medical management. For example, immunization records may be retrieved and used when a patient is determined to have recently traveled, such as through the location input devices. Therefore, if the doctor knows the patient recently was out of the country in a particular high risk location, the doctor may make an informed diagnosis or may prescribe certain medication combinations knowing there may be possible complications with drugs associated with the immunization or possible disease. For example, if a patient recently traveled to a high malaria location, then the doctor when deciding between two medications may select one that will not interfere with malaria medications in the event the patient contracted malaria. Other information, such as genetic test results may also be retrieved as these may be skewed by medicines or medicines may affect these results. Therefore, the relationship between the result and the medication may be identified to a care giver. Other events may include mental health conditions that are or are not being treated. The correlation to the mental condition and the prescription may be used to elevate a priority when a specific event is defined (such as non-filling of an antipsychotic).

FIGS. 5 and 6 are schematic diagrams of an exemplary system used to implement or practice one or more embodiments of the present invention. The doctor/prescriber prescribes a medication for patient and it is either manually or electronically entered or registered in the electronic health/medical record of the patient. The patient then has the prescription filled at the pharmacy after paying the appropriate amount as determined by the payer and the pharmacy. Conventionally, from this point forward, the physician has no visibility into whether or not the patient has filled the prescription.

At the point of filling the prescription is where exemplary embodiments of the present invention manifests itself to subscribing doctors, payers, and caregivers. The event of the prescription being filled and dispensed by the pharmacy is captured by the system. Based on a series of rules and the many events that the members have subscribed to for tracking, the system correlates the medical events from the digital/electronic sources (virtual world) and the physical world at the point of dispensing. The correlated event is then sent to the doctors, caregivers, providers, patients—those who have signed up to be notified of such events for the patient.

The system may contain a registration function for all members of the medication management ecosystem.

Prescribers, providers and caregivers register for alerts and notifications to be able to track the progress of the medication prescribed to a patient. Patients register for a variety of services including reminders. The registration system captures a profile for each member with a set of preferences depending on their respective roles. These preferences can be extended over time to accommodate new functions. Patients can also determine who has access to their data by granting access to approved authorities through a user access management layer that is part of the system allowing fine grained access and authorization to the patients' data.

Third party providers such as device manufacturers, medication manufacturers, agencies providing medication data, and commerce related functions (coupons, rebates), monitoring services, can all connect to and extend functionality within exemplary embodiments of the medication management system by registering through the third party connection system provided. These “apps” and applications can make use of technologies such as OAuth2 for authorizing applications to perform functions such as read and write data on behalf of patients into and out of the system. Hooks may be provided by the system for third party developers and their applications to register for events from the system.

The system may monitor the incoming events that are part of the medication lifecycle irrespective of how long this cycle is—in some cases a finite short duration of a specified medication and in other cases an ongoing medication regimen with scheduled refills. Exemplary embodiments may be used to retrieve information from the switch network and other sources automatically, such that additional time and commitment of a patient, care giver, or physician need not be expended to obtain the benefits described herein. Therefore, once a member has created a profile or become a member, the system will automatically correlate events to that member and provide the appropriate tracking, analysis, and actions without requiring further additional actions of any entity in the continuum. Example embodiments, however, may permit one or more entities to enter additional data that may be used according to embodiments described herein.

The system may analyze and track the lifecycle of the medication assigned to a patient irrespective of provider or prescriber systems. Exemplary embodiments of the system may be used to provide a holistic patient centric view of the medication, medical procedure, medical treatment, medical test, or other event assigned to an individual. The analytics function of the platform provides the ability to develop a score (grading against selected attributes) for each patient, medication, treatment, event, and combinations thereof that can be used to help stakeholders measure the success of a medical treatment regimen.

The system may continuously monitor streaming data coming in from many sources across prescribers, third party systems, and monitoring devices, etc. as described herein and correlate the data against rules and thresholds that are set by physicians or caregivers who are interested in or accountable for patient outcomes. The patient can also set their own alerts in their preferences and profiles. The flexible and extensible rules allow for a continuous learning feedback loop of how a medication is working in a patient based on environmental, physiological and other factors.

FIG. 5 depicts a medication lifecycle management network for tracking the medication as it makes its way from prescriber to patient and then the status returned to the prescriber. The communication network connects all participants in the ecosystem and can be WAN, LAN, Internet, Wi-fi, Bluetooth, beacon, NFC, etc. or any combination of such networks or future network technologies that connect one or more parties in the ecosystem

The system third-party registration portion allows for devices to subscribe to data feeds from the system for a variety of functions including convenience for the patient and surrounding caregivers. Examples of such conveniences can include consumer devices in the home or care facility such as display devices, audio/video interfaces such as television, radio, audio systems that can be used to remind or notify patients and/or caregivers of the status of the medication or medical event of a patient. Likewise, additional consumer devices that can be worn, inserted, or ingested by the patient or other enrolled member such as wearable computers (smart watches, etc.) can subscribe to data feeds from the system for a variety of contextual notifications.

FIGS. 3-4 are exemplary flow charts illustrating an example process for medication lifecycle management, according to an embodiment of the present invention.

A Registration process may be part of the system and may be used to collect the required data on the members who wish to participate and receive the benefits of the system. The process is not shown. Registration can be done proactively by the member or be linked automatically to a prescription and initiated from that event provided the sponsoring institution/provider is already integrated into the system. A Preference and Profile system is not shown but may be used to present options and collect preferences of members on how they want to be notified, of what event, and in what time frame. These processes are available to all members of the system

Location-based services (wi-fi, mobile phone signals and call data records, beacon, etc. . . . ) can be used to correlate events to stakeholders such as confirmations that a patient's device was at a retail pharmacy location at a specific time.

A “first-responders” user role can be defined to allow for “black box crash” in emergency room situations when patients cannot speak. This may be a setting provided by the patient or provider in the system, taking into account appropriate and relevant privacy and privacy laws and practices and allows a playback history of all medications a patient is on or has taken recently. The user of a break-glass feature can be implemented in the system to allow for emergency personnel access to the patient data when warranted.

Additional commerce services not shown here may include: marketing and informational services from any number of approved providers relevant to the system. Examples of these include but are not limited to: intervention education, wellness and fitness services, chemical dependency (rehabilitation) services, manufacturer, insurance, and/or retail rebates, etc.

Analytics may be provided to stakeholders of the system on specific events and specific metrics such as: time to fill, refill time/duration/frequency, reminders, adverse effects, etc. All of these exemplary metrics can be dimensionally analyzed according to many parameters including age, geography, date/time, diagnosis, gender, nationality, etc.

Blockchain is an append-only ledger for transactions. The blockchain is an emerging technology that has gained notoriety recently as a result of its use as the underlying distribute databased for the Bitcoin virtual currency. Recent developments are adding new capabilities to the blockchain to record the transaction between one or more parties—such as sale of property, a contract between people, etc. Exemplary embodiments of the present system may use the blockchain to record the lifecycle of events related to medication lifecycle management, including but not limited to a prescription being written, prescription being dispensed, picked up by a customer, not picked up in a certain amount of time, a prescription recently picked up and an external event occurring such as vital signs/heart rate increasing, a person found unconscious by paramedics or arrives at a hospital emergency room, and they have recently picked up a prescription. For example, the system writes a medical/medication lifecycle event to the blockchain so that the system data can be decentralized and does not need to rely on a central database owned by only one entity.

As shown and described, exemplary embodiments include a Correlation Engine that can track real-time human related events and external conditions (weather, traffic, vehicle status, time-of-day) and continuously tracks the context of the person as it relates to their medication regimen. Each event is written/stored on the blockchain by the system on behalf of the person to ensure ownership of the data. This also reduces the burden on the patient of having to enter data manually, which will help to increase data capture rates if performed automatically.

Another exemplary embodiment may incorporate “smart contracts” where a contract can be digitally represented and executed when the conditions are met. So the contracts can be self-enforcing and self-executing and these would be tied to the events on the blockchain generated by exemplary embodiments of the system. For example, the medication lifecycle management system that is tracking external signals and the person's medication may have a smart contract that says “lower health insurance rates when blood pressure is consistently below a certain level and the patient has come off the medication”. Another instance of a smart contract with caregivers may be “pay the care giver or nurse after checking in on an elderly parent and the vital signs have been checked in the home”.

The processes in this system provide a patient-centered view across providers and prescribers allowing for increased security and peace of mind for patients and their families and caregivers when a patient is traveling outside of their usual living area. Providers and doctors can manage and remain informed of a patients' medication lifecycle even as they travel.

In an exemplary embodiment, the system may be deployed as a system as a service and reside on the cloud and be accessed through a networked interface. In an exemplary embodiment, the system may also be deployed on a closed system network or server, such as in a hospital, hospice, resident care center, residential/home, etc. The system then retrieves the necessary information locally and performs the functions described herein. The system according to the closed embodiment may use the correlation engine to match members signed up through the administrative module (patients) with data retrieved from the switch before using or saving only the relevant data to reduce storage space.

Many example implementations have been described in part in the above sections of this disclosure. The system operates on computer systems that can be a combination of on-premises, in the cloud (hosted externally), mobile devices, and an extensible set of third party supplied applications and devices that extend the functionality of the system. The system can also be interfaced to any number of external systems, including television, telecommunications device for the deaf (TDD) for hearing impaired, or even tactile systems like sensor-based watches or other wearable devices where a message comes in saying that the wearer did not fill or it is time to fill a prescription.

The various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents. In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that show in the accompanying figures.

The invention claimed is:

1. A system for managing a lifecycle of a health event, comprising:
an administrative module for identifying a user in the system;
a prescription processor configured to retrieve clinical information associated with messages that pass through a network switch; and
a correlation engine configured to associate the retrieved clinical information to the user.

2. The system of claim 1, wherein the prescription processor communicates with a communication network that includes one or more collections of clinical, retail, payment, EMR aggregation, sensor-based and remote monitoring systems that are connected to clearinghouses and switches and are responsible for routing and delivery of secure messages and transactions.

3. The system of claim 1, wherein the administrative module is configured to present a user interface to a user, to retrieve information from the user, to define a user profile, user identity, and role-based access to the user members profile.

4. The system of claim 1, wherein the correlation engine uses machine learning algorithms to process incoming information and develop patterns of usage and behavior, and thereby establish a baseline for the user, wherein the system is configured to provide a notification when an event deviates from the baseline.

5. The system of claim 1, wherein the correlation engine is configured to track a medication lifecycle and provide notifications when adverse events are recognized in the medication lifecycle.

6. The system of claim 5, wherein adverse events include when a medication has been prescribed but not filled within an expiration period.

7. The system of claim 1, further comprising a third party module for retrieving external information including recall information, biological information from one or more diagnostic devices, physical information from one or more monitoring devices, prescription information, environmental information from one or more sensors, and combinations thereof.

8. The system of claim 7, wherein the correlation engine is configured to analyze the retrieved external information and determine when a notification is sent.

9. The system of claim 1, further comprising an External Partner Integration module configured to identify relevant information to a third party and provide limited information relevant to the third party in the case of a specific event.

10. The system of claim 9, wherein the External Partner Integration permits an emergency responder to retrieve limited information from the system to inform the emergency responder of a recent event.

11. The system of claim 1, further comprising an Events Engine to define what constitutes an event and a priority.

12. The system of claim 11, wherein the Events Engine is configured to define an event based on geographic location, environmental factors, acute or ambulatory, classification of medication, status of patient, caregiver instructions, patient history, and combinations thereof.

13. The system of claim 12, wherein the defined events are calendared, time-based, dynamically triggered by external environmental or contextual triggers, and combinations thereof.

14. The system of claim 1, further comprising an FDA Monitoring module configured to retrieve information from the food and drug administration to identify a medication recall.

15. The system of claim 1, further comprising a Manufacturer Processing module that includes an interface to product manufacturers configured to permit the manufacturer to send or receive data related to the health event and associated treatment plan.

16. The system of claim 1, further comprising an Integration module used to integrate information retrieved from a number of technological sources including health, wellness, or fitness tracking or diagnostics.

17. The system of claim 1, further comprising Data Analytics and Reporting module configured to provide targeted insights for specific communities of interest available via secure web and mobile channels via data analytics, reporting tools, and API's.

18. The system of claim 1, further comprising a User Managed Access (UMA) module that allows an owner of data stored in the system to electronically authorize access to the data.

19. The system of claim 1, further comprising observing or retrieving information from a switch exchange network, correlating events to the retrieved information, and/or with external information retrieved from the patient, the care giver, pharmacy, physician, manufacturer, medical or diagnostic device, regulatory agency, third party, or other source to provide notifications to one or more entities in a health care continuum related to the health event.

20. The system of claim 1, wherein the system uses self-executing, self-enforcing contracts to create agreements that are monitored by or acted on by the system and retrieved information or identified events.

21. The system of claim 1, wherein the Correlation Engine is configured to track real-time human related events and external conditions and continuously track the context of the user as it relates to their medication regimen, wherein each event is stored on a blockchain by the system on behalf of the user.

22. A method of tracking a medication lifecycle, comprising:
retrieving clinical information associated with messages that pass through a switch infrastructure in order to be processed by providers, pharmacies, or insurance companies; and
building an audit trail of a prescription associated with the clinical information by inspecting and tracking the clinical information through a lifecycle of the prescription from origination to dispensing

23. The method of claim 22, further comprising defining one or more events corresponding to the retrieved clinical information and combining the events generated from retrieved clinical information from the switch with additional data from physicians, care givers, patients, devices, manufacturers, administrative agencies, and combinations thereof to determine when event notifications should be sent.
